(19) United States
(12) Patent Application Publication
(10) Pub. No.: US 2025/0392244 A1
(43) Pub. Date: Dec. 25, 2025

(54) METHOD FOR OPERATING A GRID-CONNECTED INVERTER, INVERTER, COMPUTER PROGRAMME AND COMPUTER-READABLE MEDIUM

(71) Applicant: Siemens Aktiengesellschaft, 80333 München (DE)

(72) Inventor: Taha Lahlou, Erlangen (DE)

(73) Assignee: Siemens Aktiengesellschaft, 80333 München (DE)

(21) Appl. No.: 18/881,136

(22) PCT Filed: Jun. 15, 2023
(86) PCT No.: PCT/EP2023/066032

§ 371 Date: Jan. 3, 2025

(30) Foreign Application Priority Data
Jul. 6, 2022 (EP) 22183346.0

(51) Int. Cl. H02P 27/06; G05B 15/02

(52) U.S. Cl. CPC H02P 27/06; G05B 15/02

(57) ABSTRACT

A grid-connected inverter is connected to an electric machine. At least one circuit breaker of the inverter is switched on at a firing angle α_{ig} for which α_{ig}=180° α_{a b}+α_{c_ab} applies when the inverter operates as a generator, where α_{ab} is the angle at which the grid current drops to zero for the last time within half a period when the inverter operates as a motor, and where α_{c_ab} is a constant angle. The at least one circuit breaker of the inverter is switched off at an extinction angle αₑₓ for which αₑₓ=180°−αₐₙ+α_{c_an} applies, where αₐₙ is the angle at which the grid current when the inverter operates as a motor rises from zero for the last time before dropping to zero at the angle α_{ab}, and where α_{c_an} is a constant angle.

The invention relates to a method for operating a grid-connected inverter which is connected to an electric machine. Furthermore, the invention relates to an Inverter, a computer program and a computer-readable medium.

Inverters, which are also called power inverters, serve to convert DC voltage into AC voltage. Inverters connected to the public low-voltage grid have to satisfy various requirements. The standard DIN EN 61000:2011 “Electromagnetic Compatibility (EMC)” plays a part in this connection. In DIN EN 61000-3-12:2011 (Part 3-12: Limits-Limits for harmonic currents produced by equipment connected to public low-voltage systems with input current >16 A and ≤75 A per phase (IEC 61000-3-12:2011), limits are given for the THC (Abbreviation for: Total Harmonic Content/Current) and the PWHC (Abbreviation for: Partial Weighted Harmonic Content/Current).

There is the problem that sometimes inverters do not satisfy these requirements, for example they do not satisfy them in all operating modes. In particular, there can be the problem that the requirements for THC and PWHO are satisfied in motor operation, but not in generative operation. This, in particular, because in generative operation the current has a block form since the switching pattern of the inverter is synchronized with the line voltage.

In motor operation, current flows from the grid connected to the inverter through the inverter to an electric machine which is also connected to the inverter, in particular a connected motor, and in generative operation, in the opposite direction, i.e. from the electric machine through the Inverter to the grid.

The problems of the requirements for THC and PWHC not being satisfied in generative operation exist, for example, for grid-connected inverters with a topology with a 2-level rectifier switched with the fundamental frequency (in Germany, 50 Hz) in combination with line choke and, in particular, large direct current link. Large should in this case be taken to mean that the size is sufficient to be able to keep the voltage constant.

A method for operating a rectifier emerges from the publication “Vorzündung bei Gleichrichtern mit einer intelligenten Einspeisung” [“Preignition in rectifiers with a smart supply”] Siemens AG, Prior Art Publishing GmbH, Manfred-von-Richthofen-Str. 9, 12101 Berlin, vol. www.priorartregister.com, May 14, 2020, pages 1-14, XP007023195, in which method preignition of a switch to be commutated in generator operation and prompt switching-off of the commutating switch create an overlapping region which has a virtually natural commutating process analogous to motor operation. The rates of current rise of the line current can be reduced to the order of magnitude of the motor operation hereby.

A power conversion device emerges from EP 2 913 915 A1, to which a 3-level power conversion circuit is applied for generating three voltage levels and which is capable of exactly compensating the ON voltage drop when current flows in a semiconductor switching element or a freewheeling diode.

DE 27 46 940 A1 discloses a circuit arrangement for starting a statistical inverter with forced commutation.

JP H09 163753 A describes a control voltage correction facility for a power converter. This is particularly useful if it is applied to a inverter facility and a chopper facility which form a facility with variable speed for an induction motor and a direct current motor.

A procedure is known to the applicant for countering said problems. In this case, the inverter begins to switch before commutation of the line voltages in order to decrease the current draw rate and thus reduce the resonances in the grid owing to the high current speed.

Even if this procedure has proven itself in principle, there is still a need for suitable solutions.

It is therefore an object of the present invention to disclose a method for operating an inverter which enables optimized generative operation.

This object is achieved by a method as claimed in claim 1.

A method is disclosed for operating a grid-connected inverter which is connected to an electric machine, wherein,
in generative operation of the inverter at least one circuit breaker of the inverter is switched on at an ignition angle α_{ig}, to which

$${α}_{ig} = 180 ° - {α}_{ab} + {α}_{c \_ ab}$$

applies, where α_{ab} is the angle at which the line current in motor operation of the inverter drops to zero for the last time within a half-period, and where α_{c_ab} is a constant angle which lies, in particular, between 0° and +/−2°, preferably between 0° and +/−1°, and wherein the at least one circuit breaker of the inverter is switched off at an extinction angle αₑₓ, for which

$${α}_{ex} = 180 ° - {α}_{an} + {α}_{c \_ an}$$

applies, where αₐₙ is the angle at which the line current in motor operation of the Inverter rises from zero for the last time before dropping to zero at the angle α_{ab}, and where do α_{c_an} is a constant angle which lies, in particular, between 0° and +/−20, preferably between 0° and +/−1°.

In other words, the present invention is based on the recognition that in generative operation, a form that is mirrored to the form, in particular waveform, of the current in motor operation can be obtained. According to the Invention, the circuit breaker(s) in generative operation is/are switched on and off at defined times—dependent on motor operation—for this. This takes into account when the line current begins to rise or drop in motor operation. The angles, at which a drop to zero or a rise from zero of the current is present, are used in order to achieve an optimized, grid-friendly generative operation. The angles are inverted from motor operation in that they are subtracted from 180°. This is also referred to as mirroring by a half-period.

Expediently, a constant (positive or negative) angular value is also added in order to improve the accuracy. This, in particular, since there is a voltage drop across the diode(s) of the inverter in motor operation, whereas this does not apply to the circuit breaker(s) in generative operation. In a preferred embodiment of the method according to the invention, it is accordingly provided that the angle α_{c_ab} is suitable in motor operation of the inverter for compensating a voltage drop present across at least one diode of the inverter, and/or that the angle α_{c_an} is suitable in motor operation of the inverter for compensating a voltage drop present across at least one diode of the inverter. As a rule, the constant angles are small with a value in the single-digit range, they lie, in particular, between 0° and +/−2°, preferably between 0° and +/−1°.

In a further preferred embodiment, α__{ab} and α_{c_an} differ from one another in terms of amount and/or with regard to their sign. In other words, in order to obtain the (respective) Ignition angle for a switch-on in generative operation, preferably a different (positive or negative) constant value is added than for obtaining extinction angle for the switch-off. In a particularly preferred embodiment, α_{c_ab} has a negative and α_{c_an} a positive sign. In other words, α_{c_ab} is subtracted and α_{c_an} added.

The values for α_{c_ab} and α_{c_an} can be selected or ascertained as a function of the constructional embodiment of the inverter and, in particular, an entire system that incorporates it. For the constant correction angles it is expedient that they are identical, i.e. do not change, for all operating points.

The angular values resulting from the inverting and expedient addition of the constant angle are used according to the invention as the ignition or extinction angle for generative operation. An ignition angle or an extinction angle should be taken to mean an angle at which the respective circuit breaker(s) is/are switched on or off. It should be noted that instead of the term “ignition angle”, in principle the term “pre-ignition angle” can also be used since switch-on comes before “ignition”, here the rise in the current, and, analogously, the designation “pre-extinction angle” can also be used for the “extinction angle”, since switch-off comes before “extinguishing”, here the drop in the current to zero. However, in the present case the short designations “ignition angle” and “extinction angle” are used.

The electric machine can be, for example, a motor. Further examples of electric machines would be batteries, fuel cells or any DC power sources or current sinks or another power-electronics system, for instance another AC-DC inverter or DC-DC converter. It should be emphasized that this list is not intended to be exhaustive.

Furthermore, it should be noted that an angle basically corresponds to a time since the period length is known with the frequency. In Germany, for example, the frequency of the public grid is 50 Hz and a period duration, which corresponds to 360°, is 20 milliseconds.

According to the invention, the angle of the drop to zero at the end of the current profile in motor operation (If a half-period of 180° is being considered) is taken into account in order to obtain the (first) ignition angle for generative operation.

It should be noted in this connection, that, in particular in continuous operation of the inverter, the line current in motor operation conventionally rises exactly once from zero within a half-period of 180° and thereafter drops to zero again exactly once. For generative operation, exactly one ignition angle and exactly one extinction angle then result due to mirroring according to the invention, with the extinction angle corresponding to the mirrored angle of the rise at the start.

In intermittent operation, by contrast, conventionally it is not just one rise from zero and one drop to zero that occurs, rather at least two rises and at least two drops.

According to the Invention, it is therefore provided that in intermittent operation of the inverter, the at least one circuit breaker, after switch-on at the ignition angle α_{ig} and switch-off at the extinction angle αₑₓ, is switched-on one more time at a second ignition angle α_{ig2} and thereafter is switched off one more time at a second extinction angle αₑₓ₂, wherein

$${α}_{ig 2} = 180 ° - {α}_{ab 2} + {α}_{c 2 \_ ab}$$

applies to the second ignition angle α_{ig2}, where α_{ab2} is the angle at which the line current in motor operation of the inverter drops to zero for the last time before rising from zero at the angle αₐₙ, and where α_{c2_ab} is a constant angle which lies, in particular, between 0° and +/−2°, preferably between 0° and +/−1°,
and wherein

$${α}_{ex 2} = 180 ° - {α}_{an 2} + {α}_{c 2 \_ an}$$

applies to the second extinction angle αₑₓ₂, where αₐₙ₂ is the angle at which the line current in motor operation of the Inverter rises from zero for the last time before dropping to zero at the angle α_{b2} and where α_{c2_an} is a constant angle which lies, in particular, between 0° and +/−2°, preferably between 0° and +/−1°.

In intermittent operation, the circuit breaker is therefore switched on and off at four angles α_{ig}, αₑₓ, α_{ig2} and αₑₓ₂.

In other words, a further rise and a further drop from motor operation are also considered. As a whole, in particular, the angles of the last drop to zero, of the last rise from zero, of the penultimate drop to zero and of the penultimate rise from zero in motor operation are considered and are used—in this sequence—for the first switch-on, the first switch-off, the second switch-on and the second switch-off in generative operation, each inverted and expediently supplemented by the constant angular value.

It should be noted that α_{c2_ab} and α_{c2_an} are preferably different from one another and, more precisely, in terms of amount and/or in respect of their sign. α_{c2_ab} is preferably identical to α_{c_ab} and/or α_{c2_an} is preferably identical to α_{c_an}. However, it is also not possible to rule out that α_{c2_ab} is not identical to α_{c_ab} and/or α_{c2_an} is not identical to α_{c_an}. In a further particularly preferred embodiment, α_{c2_ab} has a negative and α_{c2_an} a positives sign.

Above all in a transition region between continuous and intermittent operation it is possible for the current to rise from zero in motor operation even more than two times and to drop to zero more than two times, in particular to rise three times and drop three times. In this case, further, previous rises in current from zero or drops in current to zero (in the half-period) in motor operation can be ignored, in the case of the threefold rise and drop in accordance with the very first rise in current and the very first drop in power (in the half-period) in motor operation. Accordingly it is also possible in this case for only the angles of the last drop to zero, of the last rise from zero, of the penultimate drop to zero and of the penultimate rise from zero in motor operation to be considered and to be used—in this sequence—for a first switch-on, first switch-off, second switch-on and second switch-off in generative operation, i.e. each inverted and expediently corrected by the constant correction angular value.

However, it is also not possible to rule out further previous rises in current from zero or drops in current to zero (in the half-period) in motor operation from being considered, and, from this, further ignition angles α_{igi} and extinction angles αₑₓᵢ (where i=3, 4, . . . ) being ascertained for generative operation and thus the circuit breaker being switched on and off at more than four ignition/extinction angles. In the case of the threefold rise and drop, accordingly a third ignition angle α_{ig3} and third extinction angle αₑₓ₃. Here the procedure can in each case then be completely analogous to obtaining the first and second ignition and extinction angles. Associated correction angles α_{ci_ab} and α_{ci_an} (where i=3, 4, . . . ) likewise lie, in particular, between 0° and +/−2°, preferably between 0° and +/−1°.

It is understood that the inverter can be embodied as a multi-phase Inverter with a plurality of circuit breakers. Then, one circuit breaker is expediently switched on at the ignition angle α_{ig} and switched off at the extinction angle αₑₓ and optionally switched on at the second ignition angle α_{ig2} and possibly even further ignition angles and switched off at the second extinction angle αₑₓ₂ and possibly even further extinction angles, and at least one further circuit breaker is switched on and off at ignition and extinction angles which are displaced by a predefined displacement value with respect to these angles. Purely by way of example it should be mentioned that an inverter is three-phase and comprises at least three circuit breakers. Then, a first circuit breaker (first phase) can be switched on and off, for example, at the Ignition or extinction angles α_{ig} and αₑₓ and optionally α_{ig2} and αₑₓ₂ (and possibly further ignition and extinction angles), a second switch (second phase) can be switched on and off, for example, at the ignition or extinction angles α_{ig}−120° (or +240°) and αₑₓ−120° (or +240°) and optionally α_{ig2}+120° (or +240°) and αₑₓ₂+120° (or +240°), and a third switch (third phase) can be switched on and off, for example, at the ignition or extinction angles α_{ig}+240° (or −120°) and αₑₓ+240° (or −120°) and optionally α_{ig2}+240° (or −120°) and αₑₓ₂+240° (or −120°).

The angles α_{ab} and αₐₙ and optionally the angles a_{ab2} and αₐₙ₂ and possibly further ignition and extinction angles are expediently ascertained. In principle, various options are available here.

It can be provided that the motor operation of the inverter is simulated, in particular using a physical simulation model, and the angles α_{ab} and αₐₙ and optionally the angles α_{ab2} and αₐₙ₂ are ascertained by means of the simulation, in particular from a simulation result. Preferably, a simulation model is used which depicts or represents the drive train, i.e. the Inverter and the connected electric machine, in particular a connected motor. In this embodiment, a simulation of motor operation, in other words, supplies the definition of the angles for generative operation. The simulation can output, for example, the current profile of the motor operation from which the angles α_{ab}, αₐₙ and optionally α_{ab2} and αₐₙ₂ can then be ascertained or inferred. If a simulation is used it can also implement the subsequent inverting and possibly the adding of a constant angle, so ignition and extinction angles for generative operation are obtained as an output. A corresponding simulation or analysis can be carried out before commissioning, also for different grid parameters. Different grid parameters can be provided, in particular, by way of standards which the inverter has to satisfy.

Alternatively or in addition it is possible that the angles α_{ab} and αₐₙ and optionally the angles α_{ab2} and αₐₙ₂ are ascertained on the basis of measuring results which are or were recorded in regular operation of the inverter. In other words, the Inverter is conventionally operated—at least temporarily—in order to obtain the current profile in motor operation, and on the basis of this it is possible according to the invention to ascertain the ignition and extinction angles for generative operation.

A further embodiment is also characterized in that the angles α_{ab} and αₐₙ and optionally the angles α_{ab2} and αₐₙ₂ are ascertained on the basis of measuring results which are or were recorded during commissioning of the inverter when it is connected to the grid, but the electric machine is not yet being operated. This, in particular, if the grid-connected Inverter is running in motor operation during commissioning and charges the DC link briefly in generative operation without drastically reducing the DC link voltage.

The method according to the invention can be used for inverters of any kind, including for existing, conventional inverters. For example, ignition and extinction angles obtained according to the invention can be set in an existing, conventional inverter, this, for example, after they have been obtained by carrying out a suitable simulation. Purely by way of example it should be mentioned that the ascertained ignition and extinction angles are input into the software of an existing, possibly also conventional inverter.

An inverter is also subject matter of the invention, comprising
a processor, and
a data storage apparatus on which computer-executable program code is stored which, when it is executed by the processor, prompts it to carry out the steps of the method according to the invention.

A correspondingly equipped inverter is suitable for carrying out the method according to the invention.

The inverter according to the invention, or an inverter which is operated according to the invention, expediently comprises a line choke and a DC link.

A further subject matter of the present invention is a computer program which comprises program code means which, when they are executed on at least one computer, prompt the at least one computer to carry out the steps of the method according to the invention.

The invention also relates to a computer-readable medium which comprises instructions which, when they are executed on at least one computer, prompt the at least one computer to carry out the steps of the method according to the invention.

The computer-readable medium can be, for example, a CD-ROM or DVD or a USB or flash memory. It should be noted that a computer-readable should be taken to mean not just a physical medium, but one which can also exist, for example, in the form of a data stream and/or a signal which represents a data stream.

Further features and advantages of the present invention will become clear on the basis of the following description of embodiments according to the invention with reference to the accompanying drawings, in which:

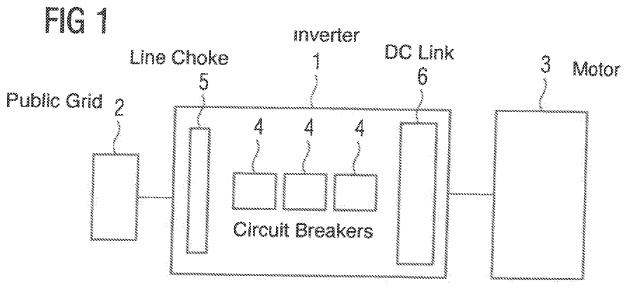

FIG. 1 shows a purely schematic representation of a grid-connected inverter as well as one connected to an electric machine,

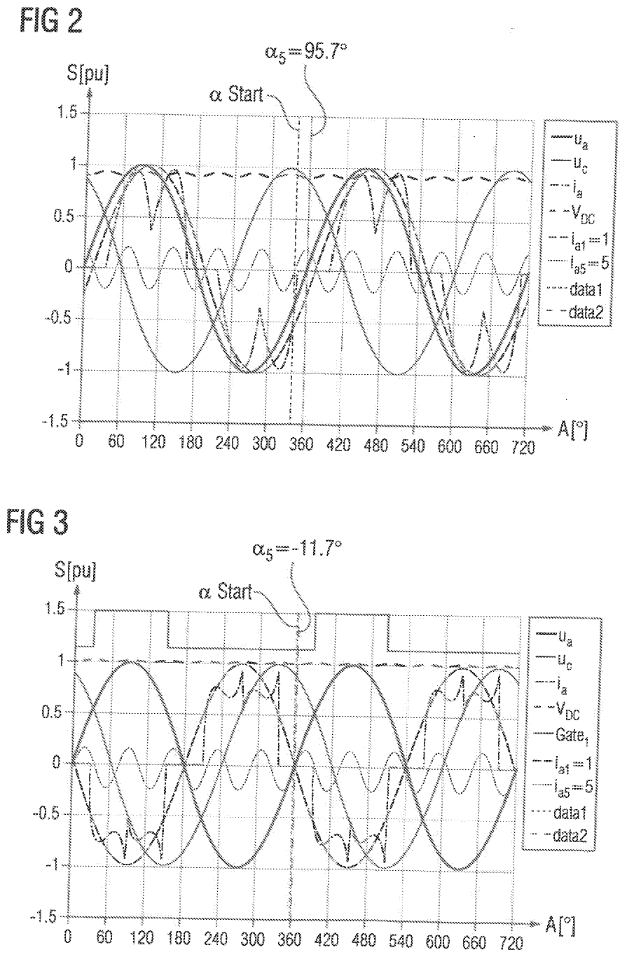

FIG. 2 shows a graph which shows, inter alia, voltages and current for the case of motor operation of the inverter from FIG. 1,

FIG. 3 shows a graph which shows, inter alia, voltages and current for the case of generative operation of the inverter from FIG. 1,

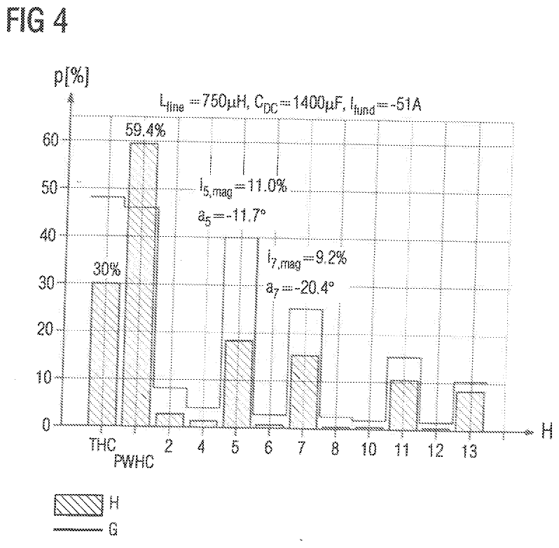

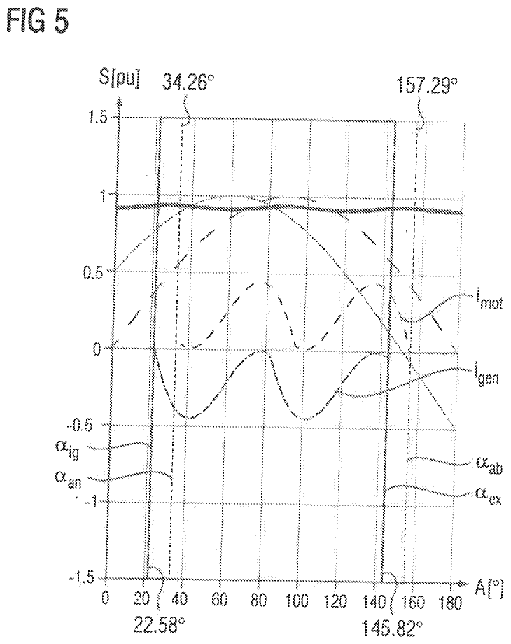

FIG. 4 shows a harmonic spectrum of the line current of the inverter from FIG. 1,

FIG. 5 shows a graph which shows, inter alia, voltages and current for motor and generative operation of the inverter after carrying out an exemplary embodiment of the method according to the invention (below the nominal current, continuous operation)

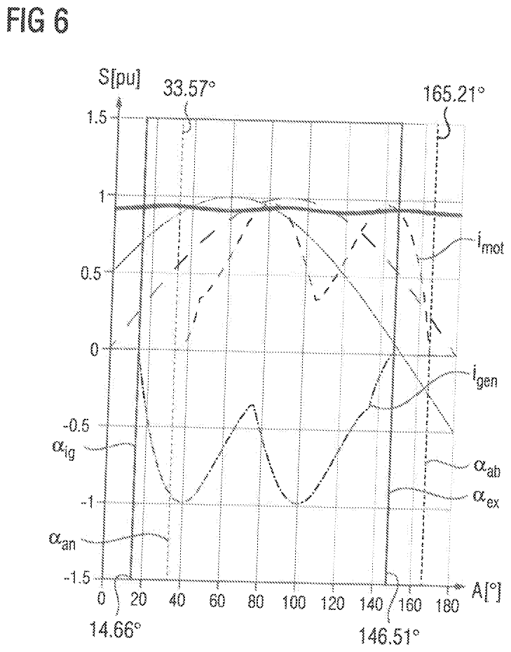

FIG. 6 shows a graph which shows, inter alia, voltages and current for motor and generative operation of the inverter after carrying out an exemplary embodiment of the method according to the invention (below the nominal current, continuous operation),

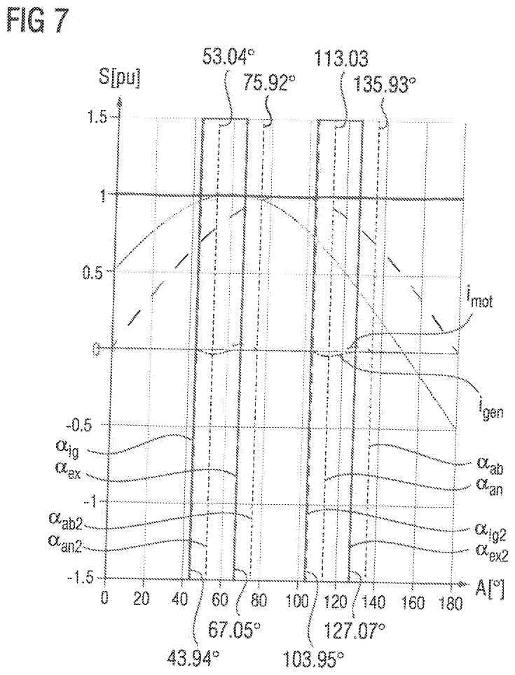

FIG. 7 shows a graph which shows, inter alia, voltages and current for motor and generative operation of the inverter after carrying out an exemplary embodiment of the method according to the invention (below the nominal current, intermittent operation), and

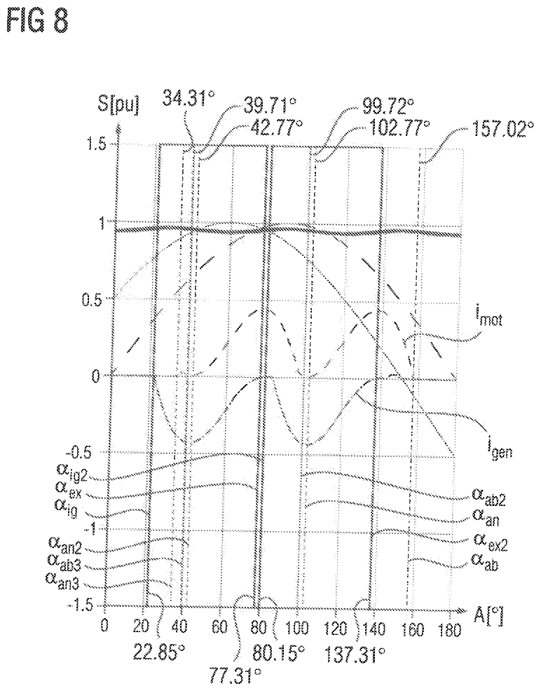

FIG. 8 shows a graph which shows, inter alia, voltages and current for motor and generative operation of the inverter after carrying out an exemplary embodiment of the method according to the invention (below the nominal current, intermittent operation).

FIG. 1 shows in a purely schematic representation an inverter 1 which is connected to the public grid 2 and to an electric machine 3 in the form of a motor. In the example represented here, the motor 3 for its part comprises an inverter which is not represented in the highly simplified FIG. 1.

As an alternative to the motor 3, the electric machine can also be, for example a battery, fuel cell or any other DC power source or current sink or another power-electronic system, for instance another AC-DC inverter or DC-DC converter.

The inverter 1 is multi-phase and has a plurality of circuit breakers 4. It also has a line choke 5 and a DC link 6. The line choke 5 serves, in particular, to suppress harmonics. It limits the current rise and can thus facilitate fewer disruptions in the line current. It should be noted that in the highly simplified FIG. 1, the internal wiring of the inverter 1 and the multi-phase connection to the public grid 2 are not represented. Furthermore, it should be noted that in addition to the three circuit breakers 4 drawn in FIG. 1 the, in this case, three-phase inverter 1 can also have or has three further circuit breakers 4 which are alternately actuated or switched with—in other words negated to—the three circuit breakers 4 shown in the Figure. Each pair of two negatively operated circuit breakers 4 forms a half bridge in a known manner. The three further circuit breakers 4 are not represented in FIG. 1 for reasons of clarity.

The inverter 1 can be, for example, a SIEMENS Inverter RGD (Regenerative Drive) or SLM (Smart Mode), with this being understood as being purely by way of example.

Limits are given for the THC and the PWHC in DIN EN 61000-3-12:2011 and these are satisfied by the inverter 1 in motor operation but not in generative operation. In motor operation, current flows from the grid 2 through the inverter 1 to the motor 3 and in generative operation, in the opposite direction, i.e. from the motor 3 through the inverter 1 to the grid 2.

In generative operation, the current has a block form since the switching pattern of the inverter 1 is synchronized with the line voltage.

The operation of the inverter 1 is shown in motor mode in FIG. 2 and in generative mode in FIG. 3.

The variables represented in the graph against the angle in degrees and listed in the associated legend are as follows:

| | |
|---|---|
| uₐ | line voltage in phase a |
| u_{c} | line voltage in phase c |
| iₐ | line current of phase a |
| iₐ₁ | fundamental wave of the current of phase a |
| iₐ₅ | 5^{th} harmonic of the current of phase a |
| V_{DC} | direct current link voltage |
| data1 | line marking the zero point |
| data2 | line marking the angle between the line voltage and the 5^{th} |
| | harmonic of the line current of phase a |
| Gate₁ | control signal of a circuit breaker 4 |

The following table compares THC and PWHC calculated by way of example for motor operation with the limits in accordance with DIN EN 61000-3-12:

| | Calculated | DIN EN 61000-3-12 |
|---|---|---|
| THC | 35.4% | 48% |
| PWHC | 16.5% | 46% |

As may be seen, the requirements for THC and PWHC of DIN EN 61000-3-12 for motor operation are satisfied.

As may be seen in FIG. 3, the current form (iₐ) in generative operation is a block and contains high di(t)/dt (diₐ (t)/dt).

The following table compares THC and PWHC calculated by way of example for generative operation with the limits in accordance with DIN EN 61000-3-12:

| | Calculated | DIN EN 61000-3-12 |
|---|---|---|
| THC | 30.0% | 48% |
| PWHC | 59.4% | 46% |

As may be seen, the limit of 46% for the PWHC is exceeded at 59.4%.

FIG. 4 shows an associated harmonic spectrum, with the limits in accordance with DIN EN 61000-3-12 also being drawn. In the legend, H stands for harmonic and G for the corresponding limits in accordance with this standard.

The afore-mentioned problem of exceeding the PWHC limit in generative operation of the inverter 1 can be solved in that in generative operation of the inverter 1, at least one circuit breaker 4 of the inverter 1, in the present case the left-hand circuit breaker 4 in FIG. 4, is switched on at an ignition angle α_{ig} to which

$${α}_{ig} = 180 ° - {α}_{ab} + {α}_{c \_ ab}$$

applies, where α_{ab} is the angle at which the line current in motor operation of the inverter 1 drops to zero for the last time within a half-period, and where α_{c_ab} is a constant angle which preferably lies between 0° and 1°, and wherein the circuit breaker 4 of the inverter 1 is switched off at an extinction angle αₑₓ to which

$${α}_{ex} = 180 ° - {α}_{an} + {α}_{c \_ an}$$

applies, where α is the angle at which the line current in motor operation of the inverter 1 rises from zero for the last time before dropping to zero at the angle α_{ab} and where α_{c_an} is a constant angle which preferably lies between 0° and 1°.

This is illustrated in more detail by way of example in FIG. 5. This Figure shows, inter alia, the profile of the line current iₘₒₜ for the case of motor operation and the profile of the line current i_{gen} for the case of generative operation which is achieved by appropriate switching of the left-hand circuit breaker 4 of the inverter 1. The signal (abbreviated to S) in pu is in each case plotted against the angle (abbreviated to A) in degrees in the graph.

Drawn in FIG. 5 are said angles α_{ab}, αₐₙ, α_{ig} and αₑₓ. The constant angles here are

$${α}_{c \_ ab} = - 0.13 ° and$$

$${α}_{c \_ an} = 0.08 ° .$$

These are added to increase the accuracy. This, since in motor operation there is a voltage drop across the diode(s) of the inverter 1, whereas this does not apply to the circuit breaker(s) 4 in generative operation. Owing to the negative values here of α_{c_ab}, the value is deducted, i.e. subtracted.

As can be inferred from FIG. 5, in the example shown the line current iₘₒₜ drops to zero in motor operation at the following angle:

$${α}_{b} = {157.29}^{∘} .$$

It also rises from zero at the following:

$${α}_{an} = 34.26 ° .$$

Together with the two constant angles α_{c_ab} and α_{c_an}, the following is obtained:

$${α}_{lg} = 180 ° - {α}_{b} + {α}_{c \_ ab} = 180 ° - 157.29 ° - 0.13 ° = 22.58 °$$

$${α}_{ex} = 180 ° - {α}_{an} + {α}_{c \_ an} = 180 ° - 34.26 ° + 0.08 ° = 145.82 °$$

FIG. 6 shows, completely analogously to FIG. 5, the profile of the line current iₘₒₜ for the case of motor operation and the profile of the line current i_{ge} for the case of generative operation, here for nominal current, i.e. 100%.

Here:

$$α = 180 ° - {α}_{ab} + {α}_{c \_ ab} = 180 ° - 165.21 ° - 0.13 ° = 14.66 °$$

$${α}_{ex} = 180 ° - {α}_{an} + {α}_{c \_ an} = 180 ° - 33.57 ° + 0.08 ° = 146.51 °$$

applies for the ignition and extinction angle for generative operation as a function of the angles α_{ab} and αₐₙ of the motor mode.

Below a certain proportion of the nominal current, the inverter 1 transfers from continuous to intermittent operation. In intermittent operation, conventionally it is not just one rise in the current from zero and one drop in the current to zero that occur (cf. FIGS. 5 and 6 and angles α_{ab} and αₐₙ therein with corresponding current rise/drop), but at least two rises and at least two drops (cf. FIG. 7 and the angles α_{ab} and αₐₙ as well as α_{ab2} and αₐₙ₂ therewith with corresponding current rise/drop).

In intermittent operation of the inverter 1, after the switch-on at an Ignition angle α_{ig} and the switch-off at an extinction angle αₑₓ, the circuit breaker 4 is therefore switched on once again at a second ignition angle α_{ig2} and thereafter switched off once again at a second extinction angle αₑₓ₂:

$${α}_{g 2} = 180 ° - {α}_{ab 2} + {α}_{c 2 \_ ab}$$

applies for the second ignition angle, where a_{ab2} is the angle at which the line current in motor operation of the inverter drops to zero for the last time before rising from zero at the angle αₐₙ, and where α_{c2_ab} is a constant angle which preferably lies between 0° and +/−1°.

Then

$${α}_{ex 2} = 180 ° - {α}_{a n 2} + {α}_{c 2 \_ an}$$

also applies for the second extinction angle, where αₐₙ₂ is the angle at which the line current in motor operation of the inverter rises from zero for the last time before dropping to zero at the angle α_{ab2}, and where α_{c2_an} is a constant angle which preferably lies between 0° and +/−1°.

In other words, in Intermittent operation, the circuit breaker is preferably switched on and off at four angles α_{ig}, αₑₓ, α_{g2} and αₑₓ₂.

Examples of intermittent operation are illustrated in FIGS. 7 and 8.

$${α}_{\_ ab} = - 0.13$$

$${α}_{c\_ an} = + 0.08$$

$${α}_{c 2 \_ ab} = - 0.13$$

$${α}_{2 \_ an} = + 0.08$$

apply for the constant angles.

As may be seen, α_{c_ab} and α_{c2_ab} as well as α_{c_an} and α_{c2_an} are identical.

$${α}_{ig} = 180 ° - {α}_{ab} + {α}_{c \_ ab} = 180 ° - 135.93 ° - 0.13 ° = 43.94$$

$${α}_{ex} = 180 ° - {α}_{an} + {α}_{c \_ an} = 180 ° - 113.03 ° + 0.08 ° = 67.05 °$$

$${α}_{g 2} = 180 ° - {α}_{ab 2} + {α}_{c 2 \_ ab} = 180 ° - 75.92 ° - 0.13 ° = 103.95 °$$

$${α}_{ex 2} = 180 ° - {α}_{an 2} + {α}_{c 2 \_ an} = 180 ° - 53.04 ° + 0.08 ° = 127.04 °$$

apply for the ignition and extinction angles in FIG. 7.

For the ignition and extinction angles in FIG. 8 applies:

$${α}_{ig} = 180 ° - {α}_{ab} + {α}_{c \_ ab} = 180 ° - 157.02 ° - 0.13 ° = 22.85 °$$

$${α}_{ex} = 180 ° - {α}_{an} + {α}_{c \_ an} = 180 ° - 102.77 ° + 0.08 ° = 77.31 °$$

$${α}_{ig 2} = 180 ° - {α}_{ab 2} + {α}_{c 2 \_ ab} = 180 ° - 99.92 ° - 0.13 ° = 80.15 °$$

$${α}_{ex 2} = 180 ° - {α}_{an 2} + {α}_{c 2 \_ an} = 180 ° - 42.77 ° + 0.08 ° = 137.31 °$$

It should be noted that above all in a transition region between continuous and intermittent operation, the current can also rise from zero more than two times and can drop to zero more than two times, in particular can rise three times and drop three times (cf. FIG. 8 and the angles α_{ab} and αₐₙ as well as α_{ab2} and αₐₙ₂ as well as α_{ab3} and αₐₙ₃ therein with corresponding current rise/drop). In this case, the first current rise (at angle αₐₙ₃) and the first current drop (at angle α_{ab3}) in the half-period in motor operation can be ignored. However, this is not imperative. It is also possible to ascertain for generative operation, for the first rise from zero and first subsequent drop to zero, corresponding mirrored ignition and extinction angles that are corrected by constant correction angles, with it then being possible to proceed completely analogously to as previously described for the first and second ignition and extinction angles α_{ig}, αₑₓ, α_{ig2}, αₑₓ₂. In other words, α_{ig3}=180°−α_{ab3}+α_{c3_ab} and αₑₓ₃=180°−α₃+α_{c3_an} would be ascertained as the third ignition and third extinction angles. The constant correction angle α_{c3_ab} would preferably be identical to α_{c_ab} and α_{c2_ab} and the constant correction angle α_{c3_an} would preferably be identical to α_{c_an} and α_{c2_an}. In principle, the process can be analogous for any possible further ignition and extinction angles (a_{igi} and aₑₓᵢ where i=4, 5, . . . ).

The ascertained ignition and extinction angles a_{ig} and aₑₓ as well as optionally α_{ig2} and αₑₓ₂ (as well as possibly further ignition and extinction angles) can then be input, for example, into the software of an existing, possibly also conventional inverter 1 in order to operate it accordingly.

As may be seen man in FIGS. 5 to 8, due to the mirroring of the angles of current rise(s) and current drop(s) from motor operation and the above-described corresponding switch-on and switch-off of the circuit breaker 4, in generative operation a form mirrored to the form, in particular waveform, of the current in motor operation is obtained. Since the requirements for THC and PWHC are adhered to in motor operation, this likewise applies to generative operation with now mirrored current profile.

It should be emphasized that the further circuit breakers 4 of the multi-phase inverter, i.e. the central and right-hand circuit breaker 4 in FIG. 1, are expediently switched on and off in a phase-shifted manner accordingly relative to the left-hand circuit breaker 4. In particular, the ignition and extinction angles α_{ig}, αₑₓ, α_{ig2}, αₑₓ₂ of the central circuit breaker 4 match the angles −120° (or +240°) calculated above. For the right-hand-hand circuit breaker 4 in FIG. 1, 240° (or +120°) in each case are expediently subtracted. This principle is sufficiently known from the prior art.

The current profiles iₘₒₜ of motor operation of the inverter 1 represented in FIGS. 5 to 8, from which the angles α_{ab}, αₐₙ, α_{ab2} and αₐₙ₂ were obtained, were obtained in the example described here by way of a simulation of motor operation of the inverter 1. A simulation model was used which depicts or represents the drive train, i.e. the inverter and the connected electric machine, in particular a connected motor. Such a simulation model preferably consists of a plurality of sub-models, in the example of FIG. 1 in particular of the following sub-models: grid model, grid filter model, grid-inverter model, DC link model, motor-inverter model and motor model. The models are characterized depending on the system and the simulation can then take place in order to obtain the angles.

Metrologically acquired data can also be used as an alternative or in addition to the simulation. For example, the inverter 1 can initially be conventionally operated at least for a certain time, i.e. without switching the circuit breakers on and off in the manner described above in order to obtain the mirrored motor current profile in generative mode. The angles α_{ab}, αₐₙ, α_{ab2} and αₐₙ₂ can then be read off or are ascertained from the measured data and mirroring can take place.

It is also possible to resort to measuring results which are or were recorded during commissioning of the inverter 1 when it is connected to the grid 2 but the electric machine 3 is not yet being operated. This, in particular, if the grid-connected inverter 1 runs in motor operation during commissioning and charges the DC link briefly in generative operation without greatly discharging the DC link voltage.

The above-described steps can be carried out by means of software and using suitable hardware. The hardware, which expediently comprises a processor and a data storage apparatus, can be part of the inverter 1. However, it can also be an item of hardware separate from the inverter 1. If a simulation is used in order to obtain the current profile iₘₒₜ of the motor operation, the simulation can likewise be carried out by means of the software.

Although the invention has been illustrated and described in detail by the preferred exemplary embodiment, it is not limited by the disclosed examples and a person skilled in the art can derive other variations herefrom without departing from the scope of the invention.

1.-12. (canceled)

13. A method for operating a grid-connected inverter which is connected to an electric machine, the method comprising:
in generative operation of the inverter, at least one circuit breaker of the inverter is switched on at an ignition angle α_{ig}, to which
$${α}_{ig} = 180 ° - {α}_{ab} + {α}_{c \_ ab}$$
applies, where α_{ab} is the angle at which the line current drops to zero for the last time within a half-period when the inverter is in motor operation, and where α_{c_ab} is a constant angle, and the at least one circuit breaker of the inverter is switched off at an extinction angle αₑₓ, to which
$${α}_{ex} = 180 ° - {α}_{an} + {α}_{c \_ an}$$
applies, where αₐₙ is the angle at which the line current in motor operation of the inverter rises from zero for the last time before dropping to zero at the angle α_{ab}, and where α_{c_an} is a constant angle; and
in intermittent operation of the inverter, the at least one circuit breaker, after switch-on at the ignition angle α_{ig} and switch-off at the extinction angle αₑₓ, is switched on once again at a second ignition angle α_{ig2} and thereafter is switched off once again at a second extinction angle αₑₓ₂, wherein
$${α}_{ig 2} = 180 ° - {α}_{ab 2} + {α}_{c 2 \_ ab}$$
applies to the second ignition angle α_{ig2}, where α_{ab2} is the angle at which the line current in motor operation of the inverter drops to zero for the last time before rising from zero at the angle αₐₙ, and where α_{c2_ab} is a constant angle,
and wherein
$${α}_{ex 2} = 180 ° - {α}_{n 2} + {α}_{c 2 \_ an}$$
applies to the second extinction angle αₑₓ₂, where αₐₙ₂ Is the angle at which the line current in motor operation of the inverter rises from zero for the last time before dropping to zero at the angle α_{ab2}, and where α_{c2_an} is a constant angle.

14. The method of claim 13, wherein α_{c_ab} lies between 0° and +/−2°.

15. The method of claim 13, wherein α_{c_ab} lies between 0° and +/−1°.

16. The method of claim 13, wherein α_{c_an} lies between 0° and +/−2°.

17. The method of claim 13, wherein α_{c_an} lies between 0° and +/−1°.

18. The method of claim 13, wherein α_{c2_ab} lies between 0° and +/−2.

19. The method of claim 13, wherein α_{c2_ab} lies between 0° and +/−1°.

20. The method of claim 13, wherein α_{c2_an} lies between 0° and +/−2°.

21. The method of claim 13, wherein α_{c2_an} lies between 0° and +/−1°.

22. The method of claim 13, wherein the angle α_{c_ab} is suitable in motor operation of the inverter for compensating a voltage drop present across at least one diode of the inverter, and/or that the angle α_{c_an} is suitable in motor operation of the inverter for compensating a voltage drop present across at least one diode of the inverter.

23. The method of claim 13, wherein α_{c_ab} and α_{c_an} differ from one another in terms of amount and/or in respect of their sign.

24. The method of claim 13, wherein α_{c2_ab} and α_{2_an} differ from one another in terms of amount and/or in respect of their sign and/or that α_{2_ab} is identical to α_{c_ab} and α_{c2_an} is identical to α_{c_an}.

25. The method of claim 13, wherein the inverter is embodied as a multi-phase inverter with a plurality of circuit breakers and one circuit breaker is switched on at the ignition angle α_{ig} and is switched off at the extinction angle αₑₓ, and at least one further circuit breaker is switched on and off at ignition and extinction angles which are displaced by a predefined displacement value with respect to these angles.

26. The method of claim 25, wherein the one circuit breaker is switched on at the second ignition angle α_{ig2} and switched off at the second extinction angle αₑₓ₂.

27. The method of claim 13, wherein the angles α_{ab} and αₐₙ are ascertained.

28. The method of claim 27, wherein the angles α_{ab2} and αₐₙ₂ are ascertained.

29. The method of claim 27, wherein the motor operation of the inverter is simulated, and the angles α_{ab2} and αₐₙ₂ are ascertained by the simulation.

30. The method of claim 27, wherein the angles α_{ab} and αₐₙ are ascertained from a simulation result.

31. The method of claim 28, wherein the motor operation of the inverter is simulated, and the angles α_{ab2} and αₐₙ₂ are ascertained by the simulation.

32. The method of claim 28, wherein the angles α_{ab2} and dₐₙ₂ are ascertained from a simulation result.

33. The method of claim 13, wherein the motor operation of the inverter is simulated using a physical simulation model.

34. The method of claim 27, wherein the angles α_{ab} and αₐₙ are ascertained based on measuring results which are or were recorded during regular operation of the inverter.

35. The method of claim 28, wherein the angles α_{ab2} and αₐₙ₂ are ascertained on the basis of measuring results which are or were recorded during regular operation of the inverter.

36. The method of claim 27, wherein the angles α_{ab} and αₐₙ are ascertained based on measuring results which are or were recorded during commissioning of the inverter when it is connected to the grid but the electric machine is not yet being operated.

37. The method of the claim 28, wherein the angles α_{ab2} and αₐₙ₂ are ascertained based on measuring results which are or were recorded during commissioning of the inverter when it is connected to the grid but the electric machine is not yet being operated.

38. An inverter, comprising:
a processor; and
a data storage apparatus on which computer-executable program code is stored which, when it is executed by the processor, prompts it to carry the method of claim 13.

39. A non-transitory computer-readable medium, comprising commands which, when they are executed on at least one computer, prompt the at least one computer to carry out the method of the claim 13.
